(19) United States
(12) Patent Application Publication
(10) Pub. No.: US 2026/0086943 A1
(43) Pub. Date: Mar. 26, 2026

(54) CACHE MANAGEMENT METHOD, CACHE MANAGEMENT DEVICE, AND ELECTRONIC APPARATUS

(71) Applicant: Samsung Electronics Co., Ltd., Suwon-si (KR)

(72) Inventors: Haitao HU, Suwon-si (KR); Hao YAN, Suwon-si (KR); Hyungsup KIM, Suwon-si (KR); Sungho YOON, Suwon-si (KR); Younsung CHU, Suwon-si (KR)

(73) Assignee: Samsung Electronics Co., Ltd., Suwon-si (KR)

(21) Appl. No.: 19/193,432

(22) Filed: Apr. 29, 2025

(30) Foreign Application Priority Data
Sep. 23, 2024 (CN) 202411329581.3

(51) Int. Cl. G06F 12/0802

(52) U.S. Cl. CPC G06F 12/0802

(57) ABSTRACT

A cache management method may include receiving a data access request associated with first data, incrementing activity information of first data, and adjusting a priority of the first data based on the incremented activity information of the first data, in response to the first data already being stored in a cache, and deleting second data, the second data being data having a lowest priority level in the cache, loading the first data into the cache, and setting the priority and the activity information of the first data, in response to the first data not already being stored in the cache and the cache being full.

### CROSS-REFERENCE TO RELATED APPLICATION

This U.S. non-provisional application claims the benefit of priority under 35 U.S.C. § 119 from Chinese Patent Application No. 202411329581.3 filed on Sep. 23, 2024 in the Chinese National Intellectual Property Administration (CNIPA) Office, the contents of which are herein incorporated by reference in its entirety.

### TECHNICAL FIELD

Some example embodiments of the inventive concepts generally relate to the technical field of data processing, and more particularly, relate to a cache management method, a cache management device, a cache management system, and/or an electronic apparatus, etc.

### BACKGROUND

At present, the commonly used cache replacement strategies are a LFU (Least Frequently Used) algorithm, a LRU (Least Recently Used) algorithm, etc.

The LFU algorithm replaces data of which access times is smallest each time, calculates a usage frequency of each piece of data stored in a cache, sorts the data from small to large based on the usage frequency, replaces the cached data which has lower usage frequency with new cache data first, and maintains the frequently used data in the cache. FIG. 1 is a diagram illustrating an example of data access of a LFU algorithm. Referring to FIG. 1, the data in the cache is arranged in an ascending order of usage frequency. When accessing data B, it is determined whether the data B is already stored in the cache first. As shown in FIG. 1, if the data B is in the cache, the data B is directly accessed from the cache and its usage frequency is increased by 1. When accessing data D, it is determined whether the data D is already stored in the cache. At this point, if the data D is in the cache, the usage frequency of the data D is increased by 1, and the data in the cache is reordered according to the usage frequency. If the usage frequency of the data D is greater than that of data C, an order of the data D and the data C is swapped. When accessing data F, if the data F is not already stored in the cache, data E with the lowest usage frequency is removed from the cache, then the data F is stored in the cache, and the usage frequency of the data F is changed to 1.

FIG. 2 is a diagram illustrating a data structure of a LRU algorithm. Referring to FIG. 2, the LRU algorithm replaces the oldest data which is not accessed (e.g., the data that has not been accessed for the longest time) each time, and directly inserts (e.g., pushes, enqueues, etc.) new data into a cache queue. If the cache queue is full, the data at the tail of the queue is deleted (e.g., popped, removed, etc.), and then the new data is inserted into the head of the queue; if the new data is in the cache queue, the new data is moved from its original position to the head of the queue. FIG. 3 is a diagram illustrating an example of data access of a LRU algorithm. Referring to FIG. 3, when data A, B, C, D, and E enter the cache queue and the queue is not full, the data A, B, C, D, and E are directly inserted into the cache queue. When new cache data F enters the cache queue and the cache queue is full, the previously cached data A at the tail of the queue will be removed; when the data C is accessed, since the data C is already in the cache queue, the data C is moved from its original position to the head of the queue; when new cache data G is accessed, since the data G is not already cached in the cache queue and the cache queue is full, the cache data B at the tail of the queue will be removed, and the data G will be inserted at the head of the queue.

### SUMMARY

Some example embodiments of the inventive concepts provides a cache management method, a cache management device, a cache management system, and/or an electronic apparatus, etc., which may manage a priority and/or activity of data so that high-frequency data and new data are retained in a cache, thereby improving a hit rate and/or access efficiency of the cache, etc.

According to at least one example embodiment of the inventive concepts, there is provided a cache management method including: receiving a data access request associated with first data, incrementing activity information of first data, and adjusting a priority of the first data based on the incremented activity information of the first data, in response to the first data already being stored in a cache, and deleting second data, the second data being data having a lowest priority level in the cache, loading the first data into the cache, and setting the priority and the activity information of the first data, in response to the first data not already being stored in the cache and the cache being full.

According to some example embodiments, the cache management method further includes: in response to the first data not already being stored in the cache and the cache being not full, loading the first data into the cache, and setting the priority and activity information of the first data.

According to some example embodiments, the cache management method further includes: determining access times of the cache in response to a time slice, decreasing a priority of each data stored in the cache and decrementing activity information of each data stored in the cache, in response to the access times being greater than a desired access threshold, and maintaining the priority of each data stored in the cache and the activity information of each data stored in the cache, in response to the access times being less than or equal to the desired access threshold.

According to some example embodiments, the priority and the activity information of the data stored in the cache are included in at least one priority list, and the at least one priority list includes a plurality of priority queues, each priority queue corresponding to a unique priority level, each priority queue including at least one node, and each node including activity information associated with data corresponding to the node.

According to some example embodiments, the adjusting of the priority of the first data based on the incremented activity information of the first data comprises, moving a node corresponding to the first data from a current i-th priority queue to a head of an (i+1)-th priority queue to adjust the priority of the first data, in response to the incremented activity information of the first data being greater than or equal to a desired activity threshold, wherein i is an integer greater than or equal to 1.

According to some example embodiments, the deleting of the second data comprises, deleting a tail node of a first priority queue, and deleting the second data from the cache.

According to some example embodiments, the setting of the priority and the activity information of the first data comprises, inserting a node corresponding to the first data into a head of a second priority queue, and assigning a value to the activity information included in the inserted node.

According to some example embodiments, wherein the decreasing of the priority of each data stored in the cache comprises, connecting a first priority queue to a tail of a second priority queue, updating a priority of an i-th priority queue to i−1, and updating the priority of the first priority queue to N, wherein N is a total number of priority levels, i is an integer greater than 1 and less than or equal to N, and the priority levels of the N-th priority queue to the first priority queue decrease sequentially.

According to some example embodiments, the activity information included in each node is in a form of an array, and the decreasing of the priority of each data stored in the cache comprises, performing a subtraction operation and/or a shift operation on the activity information included in each node to decrement the activity information of each data stored in the cache.

According to at least one example embodiment of the inventive concepts, there is provided a cache management device including: memory configured to store a cache, and processing circuitry configured to, receive a data access request associated with first data, increment activity information of the first data, and adjust a priority of the first data based on the incremented activity information of the first data, in response to the first data being stored in the cache, and delete second data, the second being data having a lowest priority level in the cache, load the first data into the cache, and set the priority and the activity information of the first data, in response to the first data not already being stored in the cache and the cache being full

According to some example embodiments, the processing circuitry is configured to load the first data into the cache, and set the priority and activity of the first data, in response to the first data being not stored in the cache and the cache being not full.

According to some example embodiments, the processing circuitry is further configured to: determine access times of the cache in response to a time slice coming; decrease a priority of each data stored in the cache and decrease an activity of each data stored in the cache, in response to the access times being greater than a desired accessing threshold; and maintain the priority and activity of each data stored in the cache unchanged, in response to the access times being less than or equal to the desired accessing threshold.

According to some example embodiments, the priority and activity of the data stored in the cache are reflected through a priority list, wherein the priority list includes a plurality of priority queues, each priority queue has a unique priority and each priority queue includes at least one node, and each node includes the activity of data corresponding to the node.

According to some example embodiments, the processing circuitry is configured to move the node corresponding to the first data from a current i-th priority queue to a head of an (i+1)-th priority queue to adjust the priority of the first data, in response to the increased activity of the first data being greater than or equal to a desired activity threshold, wherein i is an integer greater than or equal to 1.

According to some example embodiments, the processing circuitry is configured to delete a tail node of a first priority queue, and delete the second data corresponding to the tail node of the first priority queue from the cache.

According to some example embodiments, the processing circuitry is configured to insert a node corresponding to the first data into a head of a second priority queue, and assign a value to the activity included in the inserted node.

According to some example embodiments, the processing circuitry is configured to: connect a first priority queue to a tail of a second priority queue; and update a priority of an i-th priority queue to i−1, and update a priority of the first priority queue to N, wherein N is the number of priorities, i is an integer greater than 1 and less than or equal to N, and the priorities of the N-th priority queue to the first priority queue decrease sequentially.

According to some example embodiments, the activity included in each node is in a form of an array, wherein the processing circuitry is configured to perform a subtraction operation and/or a shift operation on the activity included in each node to decrease the activity of each data stored in the cache.

According to at least one example embodiment of the inventive concepts, there is provided an electronic apparatus including: at least one processor; a cache; and at least one memory storing computer executable instructions, wherein the computer executable instructions, when executed by the at least one processor, cause the at least one processor to execute the cache management method as described above.

According to at least one example embodiment of the inventive concepts, there is provided a non-transitory computer readable storage medium storing computer executable instructions, wherein the computer executable instructions, when executed by at least one processor, cause the at least one processor to execute the cache management method as described above.

The cache management method, the cache management device, the cache management system, and/or the electronic apparatus according to some example embodiments of the inventive concepts are capable of managing an activity and a priority of data in the cache, thereby retaining data with high access frequency and new data in the cache, improving a hit rate and/or data access efficiency of the cache, while reducing a burden on a processor, and/or improving a speed of the cache management.

### BRIEF DESCRIPTION OF THE DRAWINGS

FIG. 1 is a diagram illustrating an example of data access of a LFU algorithm.

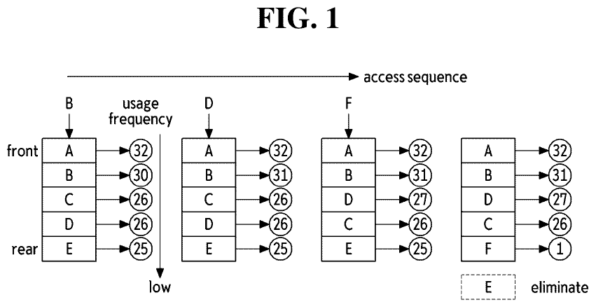

FIG. 2 is a diagram illustrating a data structure of a LRU algorithm.

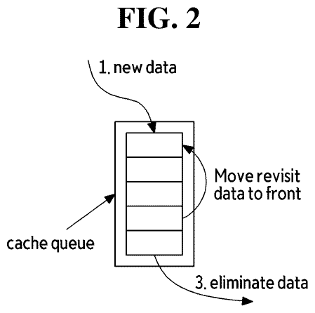

FIG. 3 is a diagram illustrating an example of data access of a LRU algorithm.

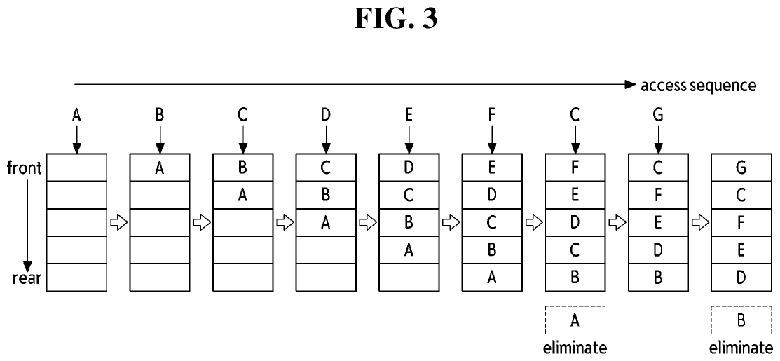

FIG. 4 is a diagram illustrating an example of a defect of a LFU algorithm.

FIG. 5 is a diagram illustrating an example of a defect of a LRU algorithm.

FIG. 6 is a diagram illustrating a computation framework of a cache according to at least one example embodiment of the inventive concepts.

FIG. 7 is a flowchart illustrating a cache management method according to at least one example embodiment of the inventive concepts.

FIG. 8 is a diagram illustrating a priority queue according to at least one example embodiment of the inventive concepts.

FIG. 9 is a diagram illustrating an example of adjusting a priority of first data according to at least one example embodiment of the inventive concepts.

FIG. 10 is a diagram illustrating an example of deleting second data among data with the lowest priority in a cache and setting a priority and an activity of first data according to at least one example embodiment of the inventive concepts.

FIG. 11 is a diagram illustrating an example of managing a priority queue according to at least one example embodiment of the inventive concepts.

FIG. 12 is a diagram illustrating another example of managing a priority queue according to at least one example embodiment of the inventive concepts.

FIG. 13 is a diagram illustrating an example of decreasing an activity of each data stored in the cache according to at least one example embodiment of the inventive concepts.

FIG. 14 is a diagram illustrating an example of implementing activity management through PIM in a DRAM buffer according to at least one example embodiment of the inventive concepts.

FIG. 15 is a diagram illustrating another example of implementing activity management through PIM in a DRAM buffer according to at least one example embodiment of the inventive concepts.

FIG. 16 is a diagram illustrating an application example of a cache management method according to at least one example embodiment of the inventive concepts.

FIG. 17 is a block diagram illustrating a cache management device according to at least one example embodiment of the inventive concepts.

FIG. 18 is a block diagram illustrating an electronic apparatus according to at least one example embodiment of the inventive concepts.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the example embodiments described herein. Rather, the example embodiments described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

Although terms such as “first,” “second,” and “third” may be used to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there may be no other elements intervening therebetween.

The terminology used herein is used for describing various examples only and should not be construed in any limiting sense. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of some example embodiments, detailed description of well-known related structures or functions will be omitted when it is deemed that such description will cause ambiguous interpretation of the disclosure.

The LFU algorithm and LRU algorithm as described above both have some defects.

At first, in the LFU algorithm, high-frequency data will reside in a cache for a long time, and occupy a cache space, so that data of which access frequency is recently high cannot reside in the cache, but is frequently swapped in and out, which may be referred to as cache-thrashing. Moreover, the access frequency of the swapped out data cannot be accumulated, which further causes it to frequently swapped in and out. On the other hand, if the accessed data is not in the cache, it needs to be loaded into the cache first and before it may be accessed, which greatly prolongs the time for accessing the data. Meanwhile, a significant amount of resources will be consumed when the data is frequently swapped in and out.

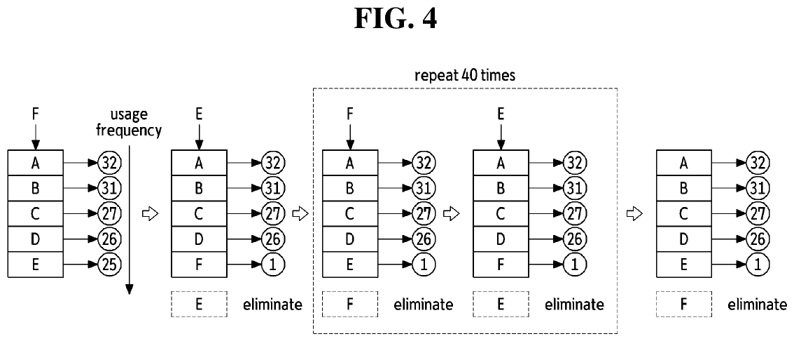

FIG. 4 is a diagram illustrating an example of a defect of a LFU algorithm. Referring to FIG. 4, when accessing data F, since the data F is not in the cache, data E with the lowest access frequency is swapped out of the cache and loaded into (e.g., swapped in) the cache. Afterwards, when accessing the data E, since the data E is not in the cache, the data F with the lowest access frequency is swapped out of the cache and the data E is swapped in the cache. Then, this process is repeated 40 times. During this period, the data E and F were frequently swapped in and out, while data A, B, C, and D were never accessed but continue to occupy cache space.

Secondly, in the LRU algorithm, if a large amount of new data is accessed once, frequently accessed data in the cache will be swapped out of the cache, while new data that is only accessed once cannot be evicted from the cache in time and occupies cache space. This results in all data being unable to be accessed through the cache, which leads to significantly prolonged data access time, reduced data access efficiency, and/or consumption of a large amount of software and/or hardware resources, etc.

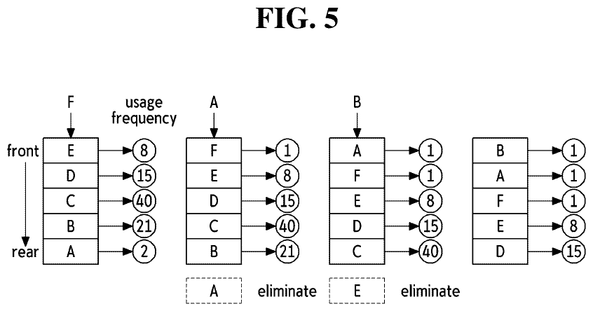

FIG. 5 is a diagram illustrating an example of a defect of a LRU algorithm. Referring to FIG. 5, although the LRU algorithm does not record access frequency of data, in order to explain the defect of the LRU algorithm, the number of cache hits is calculated based on the access frequency herein. When accessing data F, since the data F is not stored in the cache, data A located at the tail of a queue and with high access frequency is swapped out of the cache and the data F is swapped in the cache. Afterwards, when accessing the data A, it is found that the data A has already been swapped out of the cache. Therefore, data B located at the tail of the queue needs to be swapped out of the cache, and then the data A needs to be swapped in the cache. Afterwards, when accessing the data B, it is found that the data B has already been swapped out of the cache, thus data C located at the tail of the queue has to be swapped out of the cache, and then the data B is swapped in the cache. However, during this process, the data F, which is only accessed once, is never swapped out of the cache and continues to occupy cache space.

In addition, the LFU algorithm and LRU algorithm usually run in a CPU or in a simple logical processing unit. However, in order to run algorithms on the CPU, data needs to be loaded into the CPU, which consumes CPU resources. On the other hand, the logical processing unit may generally only perform extremely simple calculations and cannot perform slightly more complex calculations.

To address one or more of the above issues and/or defects, some example embodiments of the inventive concepts provide a cache management method, a cache management device, a cache management system, and/or an electronic apparatus, etc.

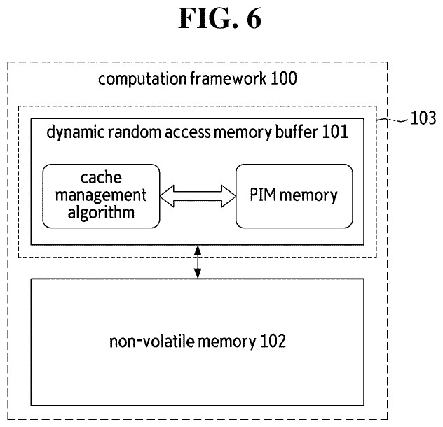

FIG. 6 is a diagram illustrating a computation framework of a cache according to at least one example embodiment of the inventive concepts. According to some example embodiments, the computation framework may be executed on at least one computing device, such as a computer, laptop, server, a smartphone, a tablet, a gaming console, a virtual reality/augmented reality device, a personal/vehicle navigation device, a vehicle control system, etc., but the example embodiments are not limited thereto.

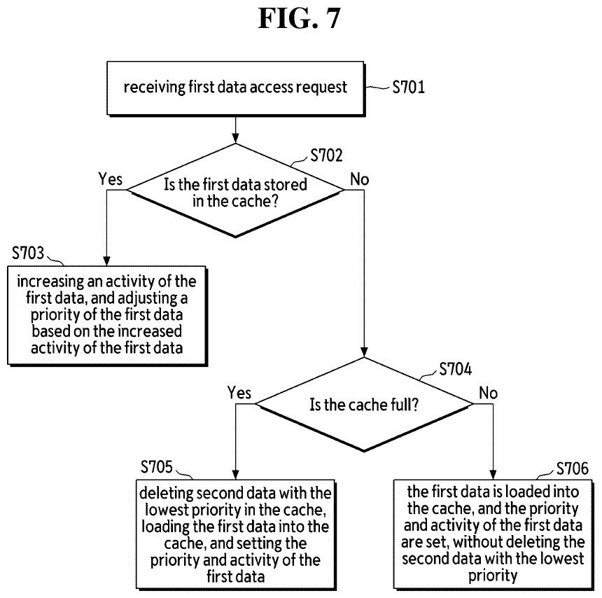

Referring to FIG. 6, the computation framework 100 of the cache includes a dynamic random access memory (DRAM) buffer 101 and/or a non-volatile memory 102, such as but not limited to SSD NAND flash memory, etc., but the example embodiments are not limited thereto. The DRAM buffer 101 may include/serve as the cache, and the cache may be used to store frequently accessed data (including data to be written to and/or read from the non-volatile memory 102), while the non-volatile memory 102 may be used to store data, but the example embodiments are not limited thereto. A cache management algorithm and PIM (In Memory Processing) according to some example embodiments of the inventive concepts may be implemented in the DRAM buffer 101, etc. The computation framework may further include other computer components, including processing circuitry 103 for performing computer operations, such as the operations shown in FIG. 7, etc., but the example embodiments are not limited thereto. According to some example embodiments, the processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

FIG. 7 is a flowchart illustrating a cache management method according to at least one example embodiment of the inventive concepts. As shown in FIG. 6, the cache management method may be executed in the DRAM buffer 101, but the example embodiments are not limited thereto.

Referring to FIG. 7, in operation S701, a data access request is received. When data is to be read from or written to the non-volatile memory 102, processing circuitry of a computing device may generate a data access request and send the data request to the DRAM buffer 101.

In operation S703, in response to first data (e.g., data to be accessed) to which the data access request is directed being stored in the cache(S702, Yes), an activity (e.g., activity information, activity indication, etc.) of the first data is increased (and/or incremented, etc.), and the DRAM buffer 101 may adjust a priority of the first data based on the increased activity of the first data(S703). In other words, the processing circuitry may determine whether the first data is already stored in the cache, and based on the results of the determination, may adjust the priority of the first data and/or increment the activity information of the first data, etc.

Herein, the activity may include the access frequency of the data, but the example embodiments of the inventive concepts are not limited thereto. For example, the activity may also include desired and/or predetermined update frequency of the data and/or the importance of the data (e.g., priority level of the data, etc.), etc. Hereinafter, it is described based on an example in which the access frequency of the data acts as the activity. When the first data is stored in the cache, the access frequency of the first data may be increased by N, where N is a positive integer that may be defined according to an actual application, for example, N may be 1.

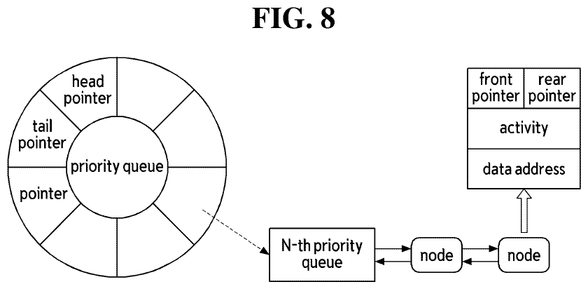

According to at least one example embodiment of the inventive concepts, the priority and/or activity of the data stored in the cache may be reflected through a priority list. Herein, the priority list may include a plurality of priority queues. FIG. 8 is a diagram illustrating a priority queue according to at least one example embodiment of the inventive concepts, but the example embodiments are not limited thereto. Referring to FIG. 8, each priority queue has a unique priority and includes at least one node, and each node includes the activity (e.g., activity information, activity history, etc.) of the data corresponding to the node. In addition, each node may also include a data address, a front pointer, and/or a rear pointer, etc., but are not limited thereto. The data address indicates an address of the data corresponding to the node in the cache. The front pointer points to a previous node of a current node, and the rear pointer points to a next node of the current node. A first priority queue is a queue with the lowest priority, and its priority may be 0, but is not limited thereto. The priority of a second priority queue may be 1, and the priorities of additional priority queues may increase sequentially, but the example embodiments are not limited thereto. Additionally, or alternatively, each node in each priority queue may be arranged in a chronological order based on access time, and when data corresponding to any node is accessed, its position in the queue may be adjusted, etc. Each node in each priority queue may be arranged in a descending order of the access frequency, and when data corresponding to any node is accessed, its position in the queue may be adjusted, but the example embodiments are not limited thereto. Each node in each priority queue may be arranged based on a comprehensive consideration of the access time and the access frequency, and when data corresponding to any node is accessed, its position in the queue may be adjusted, but the example embodiments are not limited thereto.

According to at least one example embodiment of the inventive concepts, in operation S702, the processing circuitry may adjust the priority of the first data based on the increased activity of the first data, for example, by: in response to the increased activity of the first data being greater than or equal to a desired and/or preset activity threshold, moving a node corresponding to the first data from a current i-th priority queue to the head of an (i+1)-th priority queue to adjust the priority of the first data, where i is an integer greater than or equal to 1. On the other hand, when the increased activity of the first data is less than the desired and/or preset activity threshold, the priority of the first data may be maintained unchanged. Herein, the desired and/or preset activity threshold may be determined according to and/or based on actual needs, user preferences, etc., but the example embodiments inventive concepts are not limited thereto.

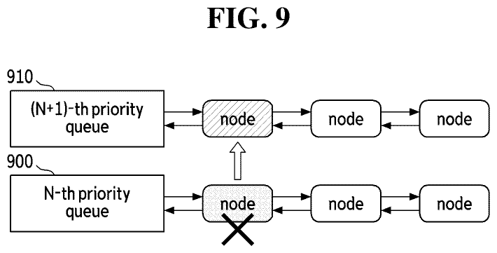

FIG. 9 is a diagram illustrating an example of adjusting a priority of first data according to at least one example embodiment of the inventive concepts. Referring to FIG. 9, when the increased activity of the first data is greater than or equal to the desired and/or preset activity threshold, the first data may be moved from the N-th priority queue 900 to the head of the (N+1)-th priority queue 910, thereby increasing the priority of the first data.

Referring to FIG. 7 again, in operation S705, in response to the first data not being stored in the cache(S702, No) and the cache being full(S704, Yes), the processing circuitry may delete a second data with the lowest priority from the cache, load the first data into the cache, and set the priority and activity of the first data(S705). Additionally, or alternatively, in operation S706, in response to the first data not being stored in the cache(S702, No) and the cache not being full(S704, No), the first data is loaded into the cache, and the priority and activity of the first data are set, without deleting the second data with the lowest priority(S706).

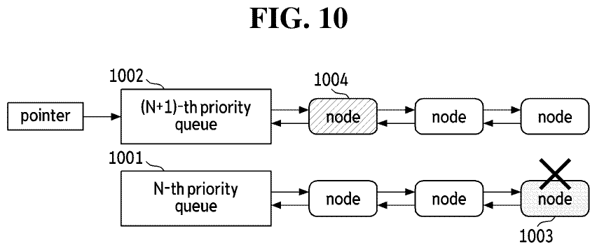

FIG. 10 is a diagram illustrating an example of deleting second data among data with the lowest priority in a cache and setting a priority and an activity of first data according to at least one example embodiment of the inventive concepts.

Referring to FIG. 10, when the cache is full, the processing circuitry may delete a tail node 1003 of the N-th priority queue 1001, and at the same time, the processing circuit may insert a node corresponding to the first data into the head node 1004 of the (N+1)-th priority queue 1002, and may set an activity value of the inserted node. Alternatively, when the cache is not full, a node corresponding to the first data may be inserted into the front node 1004 of the (N+1)-th priority queue without deleting the second data. In this case, the tail node of the queue having the priority N may be deleted. Also, data corresponding to the corresponding node may be removed from the cache, but is not limited thereto.

For example, when N is 0, if the cache is full, the processing circuit may delete the last node 1003 of the N-th priority queue 1001, where the tail node of the queue with priority 0 may be deleted. At the same time, the processing circuitry may insert a node corresponding to the first data into a head node 1004 of the (N+1)-th priority queue (e.g., a queue with priority 1, 1002), and may assign the activity included in the inserted node a value. Additionally, or alternatively, in a case where the cache is not full, the node corresponding to the first data may be directly inserted into the head node of the (N+1)-th priority queue (e.g., the queue with priority 1), and may assign the activity included in the inserted nodes a value, without deleting any nodes. When assigning the value to the activity, the activity may be set to, for example, 1, but the example embodiments of the inventive concepts are not limited thereto. As described above, the activity may represent the access frequency of the data.

According to at least one example embodiment of the inventive concepts, the cache management method further includes: determining access times of the cache in response to a time slice coming; decreasing a priority of each data stored in the cache and decreasing an activity of each data stored in the cache, in response to the access times being greater than a desired and/or preset accessing threshold; and/or maintaining the priority and activity of each data stored in the cache unchanged, in response to the access times being less than or equal to the desired and/or preset accessing threshold, but is not limited thereto.

As an example, when a time slice comes (e.g., occurs, resets, etc.), the total number of access times of all data in the cache may be determined as the access times of the cache. When the access times are greater than the desired and/or preset accessing threshold, the priority and activity of all data in the cache may be decreased (and/or reset, etc.). Herein, the desired and/or preset accessing threshold may be determined according to actual needs and/or user preferences, etc., but the example embodiments of the inventive concepts are not limited thereto.

Additionally, or alternatively, in order to improve and/or ensure normal operation of the cache, the access times of the cache may be reduced when another time slice different from the one related to determining the access times of the cache described above comes (e.g., occurs, etc.). For example, when the other time slice comes, the access times of each data in the cache may be decreased to decrease the access times of the cache. In addition, after determining the access times of each data, if the access times of one (or some) data are less than a desired and/or minimum accessing threshold for its current priority, the priority of the data may be decreased. However, the example embodiments of the inventive concepts are not limited thereto, and the access times of the cache may also be decreased in other ways. In addition, the duration of the time slice related to determining the access times of the cache described above may be the same or different from the duration of the other time slice mentioned above. When the durations of the two time slices are different, the case where two time slices come at the same time may occur. In this case, the access times of the cache may be decreased at first, and then it may be determined whether the access times of the cache exceed the desired and/or preset accessing threshold, but the example embodiments of the inventive concepts are not limited thereto.

According to at least one example embodiment of the inventive concepts, the operation of decreasing the priority of each data stored in the cache may include: connecting the first priority queue to the tail of the second priority queue; updating the priority of the i-th priority queue to i−1, and updating the priority of the first priority queue to N, where N is the number of priorities, i is an integer greater than 1 and less than or equal to N, and the priorities of the N-th priority queue to the first priority queue decrease sequentially, but the example embodiments are not limited thereto.

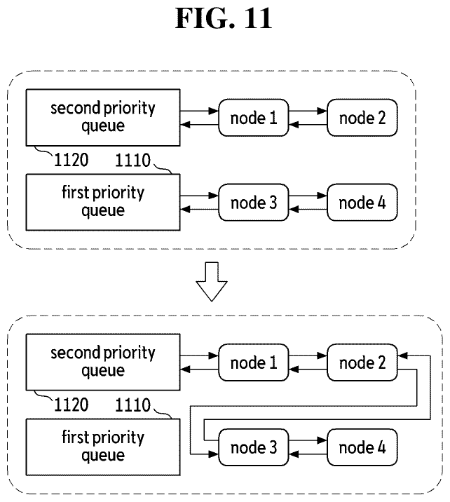

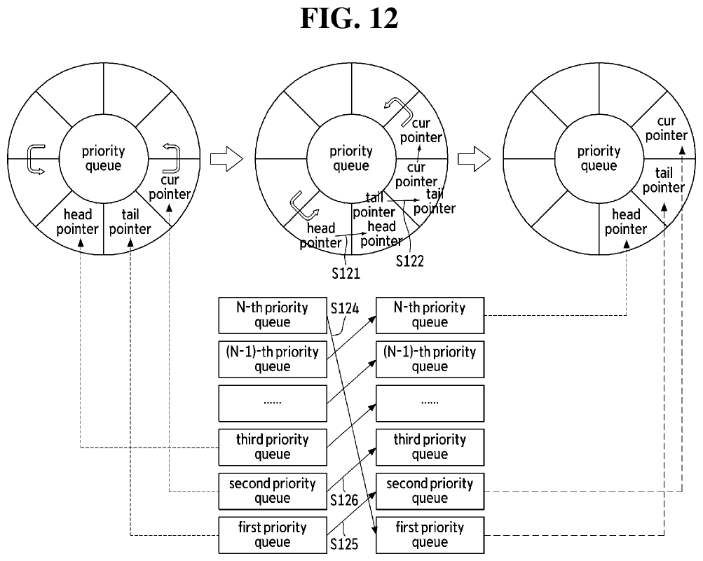

FIGS. 11 and 12 are diagrams illustrating examples of managing a priority queue according to at least one example embodiment of the inventive concepts.

Referring to FIG. 11, an operation of connecting the first priority queue 1110 to the tail of the second priority queue 1120 is shown. Specifically, processing circuitry of a computing device may connect the node at the head of the first priority queue 1110 (e.g., the queue with priority 0) to the node at the tail of the second priority queue 1120 (e.g., the queue with priority 1). For example, the processing circuitry may direct the front pointer of the node 3 to the node 2, and may direct the rear pointer of the node 2 to the node 3. As such, the node 3 is connected to the node 2, e.g., the first priority queue is linked to and follows the second priority queue, etc.

Referring to FIG. 12, an operation of updating the priority of the i-th priority queue to i−1 is shown. By changing three pointers, e.g., the pointers head, tail, and cur, the priorities of all priority queues may be updated. Specifically, processing circuitry of a computing device may point an initial head pointer to the Nth priority queue (e.g., the queue with the highest priority) S121, may point the tail pointer to the first priority queue (e.g., the queue with the lowest priority) S122, and may point the cur pointer to the second priority queue S123. When all priority queues need to be degraded, the processing circuitry may point the head pointer to the previous first priority queue S124, may point the tail pointer to the previous second priority queue S125, and may point the cur pointer to the previous third priority queue S126. In this way, when the time slice comes, the priorities of all data will decrease, improving and/or ensuring that older and less active data may be swapped out of the cache when the cache space is insufficient.

According to at least one example embodiment of the inventive concepts, the activity included in each node is in the form of an array, but is not limited thereto. In this case, the operation of decreasing the priority of each data stored in the cache may include: performing a subtraction operation and/or a shift operation on the activity included in each node to decrease the activity of each data stored in the cache.

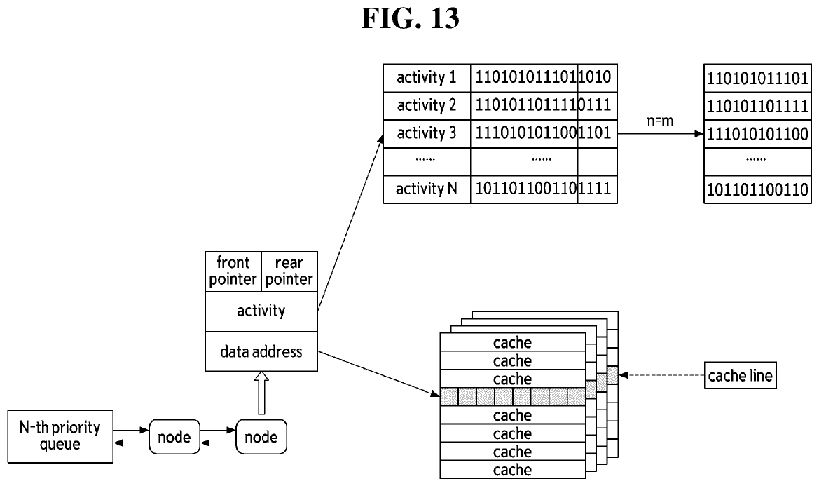

FIG. 13 is a diagram illustrating an example of decreasing an activity of each data stored in the cache according to at least one example embodiment of the inventive concepts. Referring to FIG. 13, the activities of all data in the cache are stored in an array form, but the example embodiments are not limited thereto. When the time slice comes, the activity of each data is decreased by performing the subtraction operation and/or the shift operation on all activities in the array form. The example of decreasing the activity of each data stored in the cache shown in FIG. 13 may be performed in the DRAM buffer 101 according to some embodiments of the present invention.

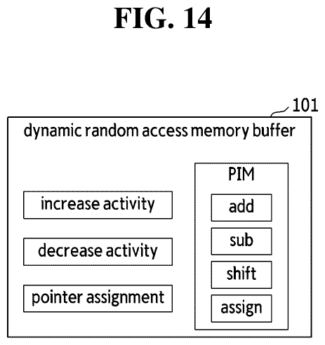

FIG. 14 is a diagram illustrating an example of implementing activity management through PIM in a DRAM buffer 101 according to at least one example embodiment of the inventive concepts. Referring to FIG. 14, the PIM may perform addition, subtraction, shift, and/or assignment, etc., operations to increase the activity, decrease the activity, and/or assign a value to the pointer, etc., but is not limited thereto.

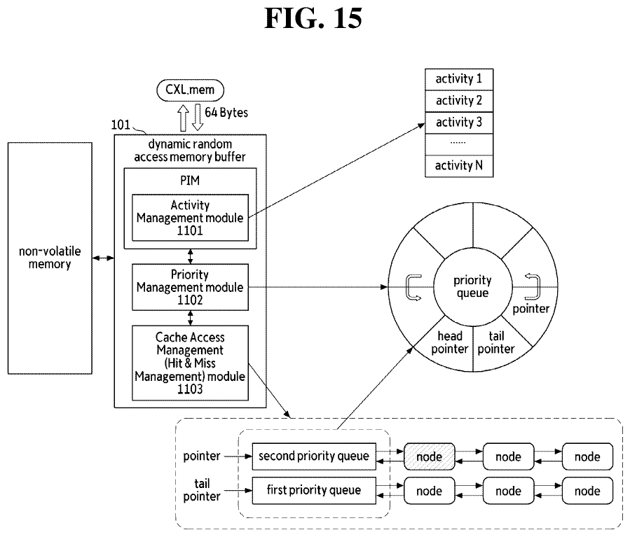

FIG. 15 is a diagram illustrating another example of implementing activity management through PIM in a DRAM buffer 101 according to at least one example embodiment of the inventive concepts. Referring to FIG. 15, an algorithm framework 1100 of the cache management method includes an Activity Management module 1101 (e.g., Activity Management device, Activity Management processing circuitry, etc.), a Priority Management module 1102 (e.g., Priority Management device, Priority Management processing circuitry, etc.), and/or a Cache Access Management (Hit & Miss Management) module 1103 (e.g., Cache Access Management device, Cache Access Management processing circuitry, etc.), etc., but the example embodiments are not limited thereto. The Activity Management module 1101 may process and/or uniformly process the activities of all data (and/or a subset of data) when the time slice comes, for example, uniformly decrease the activities of all data when the time slice comes (as shown in FIG. 13). The Activity Management module 1101 may be implemented through the PIM, but the example embodiments are not limited thereto. The Priority Management module 1102 performs priority upgradation and degradation processing (e.g., priority management processing, etc.). For example, if the activity of the data is greater than or equal to the desired and/or preset activity threshold, the priority upgradation processing is performed (as shown in FIG. 9); if the time slice comes and the access times of the cache exceeds the desired and/or preset accessing threshold, the degradation processing is performed (as shown in FIGS. 11 and 12), but the example embodiments are not limited thereto. The Cache Access Management module 1101 increases the activity (e.g., increments the activity information, etc.) of the corresponding data when the cache hits (Hit), and swaps the data with the lowest activity out of the cache, swaps the corresponding data in the cache and sets the activity of the corresponding data, when the cache misses (Miss), etc. According to some example embodiments, the Activity Management module 1101, the Priority Management module 1102, and/or the Cache Access Management (Hit & Miss Management) module 1103 may be implemented as processing circuitry.

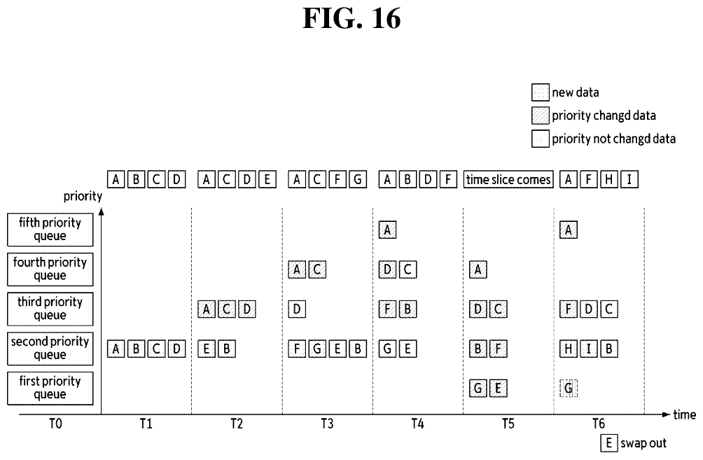

FIG. 16 is a diagram illustrating an application example of a cache management method according to at least one example embodiment of the inventive concepts. Referring to FIG. 16, at time T1, data A, B, C, and D are accessed, and at this time, the cache is empty. Therefore, data A, B, C, and D are directly loaded into the cache. At time T2, data A, C, D, and E are accessed, and at this time, data A, C, and D are in the cache, thus the activities and priories of data A, C, and D may be increased. In at least one example embodiment, by default, for each access, the activity of the data (such as the access times, etc.) is increased by 1, and the priority is increased by one level. Whether and/or how much the activity and priority are increased may be set according to specific circumstances and/or user preferences, etc. At time T3, data A, C, F, and G are accessed. At this time, data A and C are in the cache, thus the activities and priorities of data A and C may be increased, and data F and G are loaded into the cache. At time T4, data A, B, D, and F are accessed and all of them are in the cache, thus the activities and priorities of data A, B, D, and F may be increased. At time T5, when the time slice comes, the activities and priorities of all data may be decreased. The data with priority 0 (e.g., the priority of the first priority queue) is the data that is ready to be swapped out of the cache, thus priority 0 may not be decreased, while the rest of the priorities are decreased by one level. At time T6, data A, F, H, and I are accessed, and at this time, data A and F are in the cache, the activities and priorities of data A and F may be increased. Since the cache only has 8 positions, data E is swapped out of the cache, and then data H and I are swapped into the cache. The priority of each data swapped in the cache is 1, and the corresponding node is located at the head of the queue (e.g., the second priority queue) with priority 1, but the example embodiments are not limited thereto.

The cache management method according to one or more of the example embodiments of the inventive concepts is capable of managing the activity and priority of the data in the cache, thereby retaining the data with high access frequency and storing the new data in the cache, improving a hit rate and/or data access efficiency of the cache, while reducing a burden on a processor and/or processing circuitry and improving a speed of the cache management.

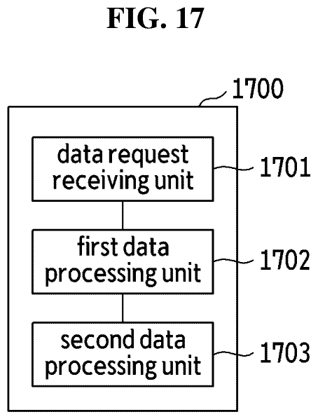

FIG. 17 is a block diagram illustrating a cache management device according to at least one example embodiment of the inventive concepts.

Referring to FIG. 17, the cache management device 1700 according to at least one example embodiment of the inventive concepts includes a data request receiving unit 1701, a first data processing unit 1702, and/or a second data processing unit 1703, etc., but the example embodiments are not limited thereto, and for example, the cache management device may include a greater or lesser number of components.

The data request receiving unit 1701 receives a data access request. The first data processing unit 1702 increases an activity (e.g., increments the activity information, etc.) of first data, and adjusts a priority of the first data based on the increased activity of the first data, in response to the first data to which the data access request is directed being stored in the cache. The second data processing unit 1703 deletes second data among data with the lowest priority in the cache, loads the first data into the cache, and sets the priority and activity of the first data, in response to the first data being not stored in the cache and the cache being full.

According to at least one example embodiment of the inventive concepts, the second data processing unit 1703 may load the first data into the cache, and set the priority and activity of the first data, in response to the first data not being stored in the cache and the cache not being full.

According to at least one example embodiment of the inventive concepts, the cache management device 1700 further includes a third data processing unit 1704, but is not limited thereto. The third data processing unit 1704 may determine access times of the cache in response to a time slice coming; decrease a priority of each data stored in the cache and decrease an activity (e.g., decrement the activity information, etc.) of each data stored in the cache, in response to the access times being greater than a desired and/or preset accessing threshold; and maintain the priority and activity of each data stored in the cache unchanged, in response to the access times being less than or equal to the desired and/or preset accessing threshold.

According to at least one example embodiment of the inventive concepts, the priority and activity of the data stored in the cache are reflected through a priority list, where the priority list includes a plurality of priority queues, each priority queue has a unique priority and each priority queue includes at least one node, and each node includes the activity of data corresponding to the node. According to some example embodiments, the first data processing unit 1702, the second data processing unit 1703, and/or the third data processing unit 1704 may be implemented as processing circuitry.

According to at least one example embodiment of the inventive concepts, the first data processing unit 1702 may move a node corresponding to the first data from a current i-th priority queue to a head of an (i+1)-th priority queue to adjust the priority of the first data, in response to the increased activity of the first data being greater than or equal to a desired and/or preset activity threshold, where i is an integer greater than or equal to 1.

According to at least one example embodiment of the inventive concepts, the second data processing unit 1703 may delete a tail node of a first priority queue, and may delete the second data corresponding to the tail node of the first priority queue from the cache, but is not limited thereto.

According to at least one example embodiment of the inventive concepts, the second data processing unit 1703 may insert a node corresponding to the first data into a head of a second priority queue, and may assign a value to the activity included in the inserted node, but is not limited thereto.

According to at least one example embodiment of the inventive concepts, the third data processing unit 1704 may connect the first priority queue to a tail of the second priority queue; may update a priority of the i-th priority queue to i−1, and may update the priority of the first priority queue to N, where N is the number of priorities, i is an integer greater than 1 and less than or equal to N, and the priorities of the N-th priority queue to the first priority queue decrease sequentially, but the example embodiments are not limited thereto.

According to at least one example embodiment of the inventive concepts, the activity included in each node is in the form of an array, and the third data processing unit 1704 may perform a subtraction operation and/or a shift operation on the activity included in each node to decrease the activity of each data stored in the cache, but the example embodiments are not limited thereto.

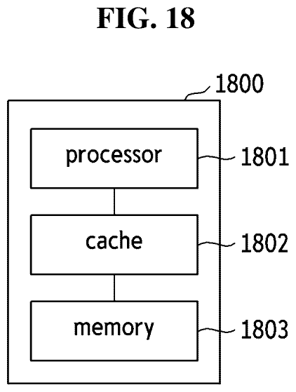

FIG. 18 is a block diagram illustrating an electronic apparatus according to at least one example embodiment of the inventive concepts. Referring to FIG. 18, the electronic apparatus 1800 includes at least one processor 1801 (e.g., processing circuitry, etc.), at least one cache 1802, and/or at least one memory 1803, etc., but the example embodiments are not limited thereto. The memory 1803 may store computer executable instructions, when executed by the processor 1801, which cause the processor 1801 to execute the cache management method according to one or more example embodiments of the inventive concepts.

As an example, the electronic apparatus 1800 may be a PC, a tablet device, a personal digital assistant, a smart phone, and/or any other device capable of executing the above instructions. Here, the electronic apparatus 1800 does not have to be a single electronic apparatus, but may also be an assembly of any device and/or circuit capable of executing the above instructions (and/or instruction set) alone and/or jointly. The electronic apparatus 1800 may also be a part of an integrated control system and/or system manager, and/or may be configured as a portable electronic apparatus interconnected with local and/or remote (e.g., via wireless transmission) by at least one interface. In addition, the electronic apparatus 1800 may also include a video display (for example, a liquid crystal display, light emitting diode display, etc.) and a user interaction interface (such as a keyboard, a mouse, a touch input device, a touchscreen, etc.). All components of the electronic apparatus 1800 may be connected to each other via a bus and/or network.

The processor 1801 (e.g., processing circuitry, etc.) may include a central processing unit (CPU), a graphics processing unit (GPU), a programmable logic device, a dedicated processor system, a microcontroller, and/or a microprocessor, but is not limited thereto. For example only and without limitation, the processor 1801 may also include an analog processor, a digital processor, a microprocessor, a multi-core processor, a processor array, a network processor, etc.

The processor 1801 may run computer executable instructions and/or program code stored in the memory 1803, wherein the memory 1803 may further store data. Instructions and data may further be transmitted and received through the network via at least one network interface device, wherein the network interface device may adopt any known transmission protocol.

The memory 1803 may be integrated with the processor 1801, for example, a RAM and/or a flash memory is arranged in an integrated circuit microprocessor or the like. In addition, the memory 1803 may include independent devices, such as an external disk drive, a storage array, and/or other storage devices that may be used by any database system. The memory 1803 and the processor 1081 may be operatively coupled, and/or may communicate with each other, for example, through an I/O port, a network connection, etc., so that the processor 1801 may read files stored in the memory 1803.

According to at least one example embodiment of the inventive concepts, there is also provided a non-transitory computer readable storage medium, where computer readable instructions stored on the non-transitory computer readable storage medium, when executed by at least one processor, cause the at least one processor to execute the cache management method according to one or more of the example embodiments of the inventive concepts.

The cache management method according to one or more of the example embodiments of the inventive concepts may be written as a computer program and stored on a non-transitory computer readable storage medium. Examples of the non-transitory computer readable storage medium include: read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), a card type memory such as multimedia card, secure digital (SD) card or extreme digital (XD) card, magnetic tapes, floppy disks, magneto-optical data storage devices, optical data storage devices, hard disks, solid-state disks, and any other device that is configured to store the instructions and/or software and any associated data, data files, and data structures in a non-transitory manner and providing the instructions or software and any associated data, data files, and data structures to a processor and/or computer so that the processor and/or computer may execute the computer program. The computer program in the above-mentioned non-transitory computer readable storage medium may run in an environment deployed in computer equipment such as a client, a host, an agent device, a server, etc. In addition, the computer program and any associated data, data files, and data structures are distributed over network-coupled computer systems so that the computer program and any associated data, data files, and data structures are stored, accessed, and executed in a distributed fashion by one or more processors or computers.

The cache management method, the cache management device, the cache management system, and/or the electronic apparatus according to one or more example embodiments of the inventive concepts are capable of improving and/or solving the problem of old data with high access frequency being unable to be timely swapped out of the cache and new data being unable to be swapped in the cache in the LFU algorithm, and/or improving and/or solving the problem of new data with low access frequency quickly replacing data with high access frequency in the LRU algorithm, etc.

In addition, the cache management method, the cache management device, the cache management system, and/or the electronic apparatus, etc., according to one or more example embodiments of the inventive concepts are capable of performing most of operations through PIM, thereby reducing and/or avoiding the waste of software and/or hardware resources and/or time, etc.

In addition, the cache management method, the cache management device, the cache management system, and/or the electronic apparatus, etc., according to one or more example embodiments of the inventive concepts are capable of improving a hit rate, while reducing a burden on a processor and improving a speed of the cache management.

Some example embodiments of the inventive concepts have been described in detail above. Although some example embodiments have been illustrated and described, those of ordinary skill in the art should understand that changes and modifications may be made to these example embodiments without departing from the scope and/or principles of the example embodiments of the inventive concepts as defined by the claims and their equivalents, and these changes and modifications should be within the protection scope of the claims of the inventive concepts.

What is claimed is:

1. A cache management method, comprising:
receiving a data access request associated with first data;
incrementing activity information of the first data, and adjusting a priority of the first data based on the incremented activity information of the first data, in response to the first data already being stored in a cache; and
deleting second data, the second data being data having a lowest priority level in the cache, loading the first data into the cache, and setting the priority and the activity information of the first data, in response to the first data not already being stored in the cache and the cache being full.

2. The cache management method of claim 1, further comprising:
in response to the first data not already being stored in the cache and the cache being not full,
loading the first data into the cache; and
setting the priority and activity information of the first data.

3. The cache management method of claim 1, further comprising:
determining access times of the cache in response to a time slice;
decreasing a priority of each data stored in the cache and decrementing activity information of each data stored in the cache, in response to the access times being greater than a desired access threshold; and
maintaining the priority of each data stored in the cache and the activity information of each data stored in the cache, in response to the access times being less than or equal to the desired access threshold.

4. The cache management method of claim 1, wherein
the priority and the activity information of the data stored in the cache are included in at least one priority list; and
the at least one priority list includes a plurality of priority queues, each priority queue corresponding to a unique priority level, each priority queue including at least one node, and each node including the activity information associated with data corresponding to the node.

5. The cache management method of claim 4, wherein the adjusting of the priority of the first data based on the incremented activity information of the first data comprises:
moving the node corresponding to the first data from a current i-th priority queue to a head of an (i+1)-th priority queue to adjust the priority of the first data, in response to the incremented activity information of the first data being greater than or equal to a desired activity threshold, wherein i is an integer greater than or equal to 1.

6. The cache management method of claim 4, wherein the deleting of the second data comprises:
deleting a tail node of a first priority queue; and
deleting the second data from the cache.

7. The cache management method of claim 4, wherein the setting of the priority and the activity information of the first data comprises:
inserting a node corresponding to the first data into a head of a second priority queue; and
assigning a value to the activity information included in the inserted node.

8. The cache management method of claim 3, wherein the decreasing of the priority of each data stored in the cache comprises:
connecting a first priority queue to a tail of a second priority queue;
updating a priority of an i-th priority queue to i−1; and
updating the priority of the first priority queue to N, wherein N is a total number of priority levels, i is an integer greater than 1 and less than or equal to N, and the priority levels of an N-th priority queue to the first priority queue decrease sequentially.

9. The cache management method of claim 3, wherein
the activity information included in each node is in a form of an array; and
the decreasing of the priority of each data stored in the cache comprises:
performing a subtraction operation and/or a shift operation on the activity information included in each node to decrement the activity information of each data stored in the cache.

10. A cache management device, comprising:
memory configured to store a cache; and
processing circuitry configured to execute computer readable instructions to,
receive a data access request associated with first data;
increment activity information of the first data, and adjust a priority of the first data based on the incremented activity information of the first data, in response to the first data being stored in the cache; and
delete second data, the second data being data having a lowest priority level in the cache, load the first data into the cache, and set the priority and the activity information of the first data, in response to the first data not already being stored in the cache and the cache being full.

11. The cache management device of claim 10, wherein the processing circuitry is further configured to execute the computer readable instructions to:
in response to the first data not already being stored in the cache and the cache being not full,
loading the first data into the cache; and
setting the priority and activity information of the first data.

12. The cache management device of claim 10, wherein the processing circuitry is further configured to execute the computer readable instructions to:
determine access times of the cache in response to a time slice;
decrease a priority of each data stored in the cache and decrementing activity information of each data stored in the cache, in response to the access times being greater than a desired access threshold; and
maintain the priority of each data stored in the cache and the activity information of each data stored in the cache, in response to the access times being less than or equal to the desired access threshold.

13. The cache management device of claim 10, wherein
priority and activity information of each data stored in the cache are included in at least one priority list; and
the at least one priority list includes a plurality of priority queues, each priority queue corresponding to a unique priority level, each priority queue including at least one node, and each node including the activity information associated with data corresponding to the node.

14. The cache management device of claim 13, wherein the adjusting of the priority of the first data based on the incremented activity information of the first data comprises:
moving the node corresponding to the first data from a current i-th priority queue to a head of an (i+1)-th priority queue to adjust the priority of the first data, in response to the incremented activity information of the first data being greater than or equal to a desired activity threshold, wherein i is an integer greater than or equal to 1.

15. The cache management device of claim 13, wherein the deleting of the second data comprises:
deleting a tail node of a first priority queue; and
deleting the second data from the cache.

16. The cache management device of claim 13, wherein the setting of the priority and the activity information of the first data comprises:
inserting a node corresponding to the first data into a head of a second priority queue; and
assigning a value to the activity information included in the inserted node.

17. The cache management device of claim 12, wherein the decreasing of the priority of each data stored in the cache comprises:
connecting a first priority queue to a tail of a second priority queue;
updating a priority of an i-th priority queue to i−1; and
updating the priority of the first priority queue to N, wherein N is a total number of priority levels, i is an integer greater than 1 and less than or equal to N, and the priority levels of the N-th priority queue to the first priority queue decrease sequentially.

18. The cache management device of claim 12, wherein
the activity information included in each node is in a form of an array; and
the decreasing of the priority of each data stored in the cache comprises:
performing a subtraction operation and/or a shift operation on the activity information included in each node to decrement the activity information of each data stored in the cache.

19. An electronic apparatus, comprising:
at least one processor;
a cache; and
at least one memory storing computer executable instructions,
wherein the computer executable instructions, when executed by the at least one processor, cause the at least one processor to execute the cache management method of claim 1.

20. A non-transitory computer readable storage medium storing computer executable instructions, wherein the computer executable instructions, when executed by at least one processor, cause the at least one processor to perform the cache management method of claim 1.
